(19) United States
(12) Patent Application Publication
(10) Pub. No.: US 2023/0201958 A1
(43) Pub. Date: Jun. 29, 2023

(54) LASER PROCESSING APPARATUS AND LASER PROCESSING METHOD

(71) Applicant: Mitsubishi Electric Corporation, Tokyo (JP)

(72) Inventors: Takanori MIYAZAKI, Tokyo (JP); Daisuke KASHIBA, Aichi (JP)

(73) Assignee: Mitsubishi Electric Corporation, Tokyo (JP)

(21) Appl. No.: 17/798,890

(22) PCT Filed: May 29, 2020
(86) PCT No.: PCT/JP2020/021296

§ 371 Date: Aug. 11, 2022

(51) Int. Cl. B23K 26/04; B23K 26/53

(52) U.S. Cl. CPC B23K 26/048; B23K 26/53

(57) ABSTRACT

The laser processing apparatus according to this disclosure includes a laser oscillator to generate laser light, a processing table to place a workpiece thereon, the workpiece having a protective sheet on a surface thereof, the protective sheet including a laser light absorbing layer, a laser head to process the workpiece with the laser light, and a control unit to adjust a position of the laser head so that a focal position of the laser light is brought to a position away from the surface of the workpiece toward the laser head, and to control power of the laser light so that marking is provided by causing the laser light absorbing layer to absorb the laser light and thus transforming the inside of the protective sheet.

### TECHNICAL FIELD

This disclosure relates to a laser processing apparatus and a laser processing method.

### BACKGROUND TECHNOLOGY

The laser processing apparatus is known as an apparatus that performs cutting processing on a workpiece. The laser processing apparatus performs cutting processing on a workpiece by moving its laser head relative to the workpiece while radiating laser light from the laser head to the workpiece. In conventional laser processing, a method of laser processing is known in which the laser processing is performed with a protective sheet attached on the surface of the workpiece to protect the workpiece from being damaged. In some cases when laser processing is performed on a workpiece with a protective sheet attached, marking is provided on the protective sheet in order to put some information about the workpiece. For example, a laser processing apparatus which performs marking processing on the protective sheet of a workpiece is known (see, for example, Patent Document 1 below).

### PRIOR ART LITERATURE

### Patent Documents

[Patent Document 1] Japanese Unexamined Patent Publication No. 2018-167294

### SUMMARY OF THE INVENTION

### Problem to be Solved by the Invention

The conventional technology, however, has the following problems. Regarding the laser processing apparatus described in Patent Document 1, there is a disclosure about how to form marking only on the protective sheet. This laser processing apparatus adjusts power of the laser light and limits the machining range to a predetermined depth so that the protective sheet is not penetrated. However, controlling a laser processing apparatus so that the protective sheet is not penetrated is generally difficult, and strict machining conditions must be set. In addition, once the laser light penetrates the protective sheet, the laser light, even if it is very small in amount, reaches the workpiece, causing a damage on the workpiece.

This invention is made in view of the above-described problems and aims to provide a laser processing apparatus which, when processing a workpiece with a protective sheet attached, can provide marking on the protective sheet without damaging the workpiece.

### Means for Solving the Problems

In order to solve the problem and achieve the objective, which are described above, a laser processing apparatus according to this disclosure includes a laser oscillator to generate laser light, a processing table to place a workpiece thereon, the workpiece having a protective sheet on a surface thereof, the protective sheet including a laser light absorbing layer, a laser head to process the workpiece with the laser light, and a control unit to adjust a position of the laser head so that a focal position of the laser light is brought to a position away from the surface of the workpiece toward the laser head, and to control power of the laser light so that marking is provided by causing the laser light absorbing layer to absorb the laser light and thus transforming the inside of the protective sheet.

### Effects of the Invention

The effect of the laser processing apparatus according to this disclosure is that marking on a protective sheet can be performed without damaging a workpiece.

### BRIEF DESCRIPTIONS OF THE DRAWINGS

FIG. 1 shows a configuration diagram of a laser processing apparatus according to Embodiment 1.

FIG. 2 shows an enlarged view near a processing point of a workpiece in FIG. 1.

FIG. 3A is a schematic layout when processing is performed by the laser processing apparatus according to Embodiment 1.

FIG. 3B is a schematic diagram after processing by the laser processing apparatus according to Embodiment 1.

FIG. 4A is a diagram showing a protective sheet after processing by the laser processing apparatus according to Embodiment 1.

FIG. 4B is a diagram showing a workpiece after processing by the laser processing apparatus according to Embodiment 1.

FIG. 5 is a flowchart showing a flow of laser processing by the laser processing apparatus according to Embodiment 1.

FIG. 6 shows a configuration diagram of a laser processing apparatus according to Embodiment 2.

FIG. 7 shows an enlarged view near a processing point of a workpiece in a general example of a laser processing apparatus using an assist gas.

FIG. 8 shows an enlarged view near a processing point of a workpiece of the laser processing apparatus according to Embodiment 2.

FIG. 9A is a cross-sectional view of a laser head along the X-X line in FIG. 8.

FIG. 9B is a cross-sectional view of a laser head according to a variation of Embodiment 2.

FIG. 10 shows a configuration diagram of a laser processing apparatus according to Embodiment 3.

FIG. 11 shows a plan view of a processing table according to Embodiment 3.

### EMBODIMENTS FOR CARRYING OUT THE INVENTION

Hereinafter, laser processing apparatuses according to the embodiments of this disclosure will be described with reference to drawings. In the drawings, the same symbols are assigned to the same or equivalent parts. Duplicate explanations will be simplified or omitted as appropriate. Note that the present invention is not limited by the embodiments described below. In the drawings described below, the scale of each component may be different from the actual scale.

### Embodiment 1

A laser processing apparatus according to Embodiment 1 will be described below.

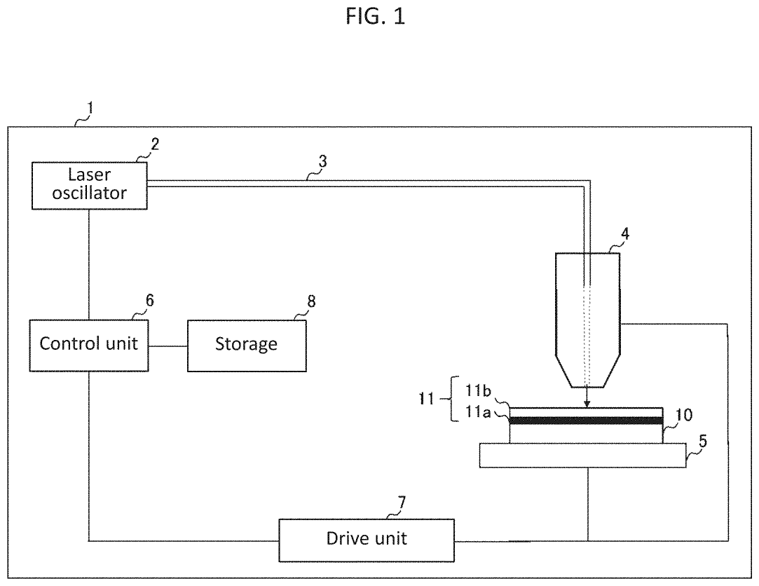

FIG. 1 shows a configuration diagram of the laser processing apparatus 1 according to Embodiment 1. The laser processing apparatus 1 includes a laser oscillator 2, a transmission unit 3, a laser head 4, a processing table 5, a control unit 6, a drive unit 7, and a storage 8. The laser processing apparatus 1 performs laser processing such as cutting, grooving, and drilling on a workpiece, for example, a plate-shaped metal workpiece.

The laser oscillator 2 is, for example, a fiber laser oscillator, producing laser light. The laser light produced by the laser oscillator 2 is introduced to the laser head 4 via the transmission unit 3 such as an optical fiber. Note that the laser oscillator 2 may be an oscillator other than a fiber laser oscillator, such as a carbon dioxide laser oscillator, a YAG laser oscillator, or a YVO laser oscillator. The laser oscillator 2 is connected to a control unit, which controls power and the like of the laser light.

The laser head 4 radiates the laser light introduced through the transmission unit 3 and processes a workpiece 10. The laser head 4, connected to the drive unit 7, move in the horizontal and vertical directions with respect to the workpiece 10. By radiating the laser light from the laser head 4, the workpiece 10 can be processed into a desired shape.

The laser processing apparatus 1 includes the processing table 5. The laser processing apparatus 1 performs processing on the workpiece 10 by radiating laser light from the laser head 4, with the workpiece 10 being placed on the processing table 5. In the following description, it is assumed that, when the workpiece 10 is set, the top surface of the workpiece is the surface facing the laser head 4 and the back surface thereof is the surface that contacts the processing table 5.

The processing table 5 is connected to the drive unit 7. Thus, the processing table 5 is driven by the drive unit 7. The action of the processing table 5 causes the workpiece 10 placed on the processing table 5 to move. By moving the processing table 5 itself, the workpiece 10 may be moved together with the processing table 5. By using a mechanism, such as rollers, provided to the processing table 5, the workpiece 10 may be moved on the processing table 5.

The control unit 6 controls other units and components of the laser processing apparatus 1. In addition, the control unit 6 also functions as a processing unit to process data involved with the operation of the laser processing apparatus 1. The control unit 6 includes, for example, a CPU, a main memory a wired or wireless communication device, an input/output interface used for communication with various external devices, an input device such as a keyboard or mouse, a display device such as a display monitor, and a computer device that executes various programs necessary for the operation and data processing of the laser processing apparatus 1.

In the laser processing apparatus 1, the control unit 6 is connected to the laser oscillator 2, the drive unit 7, and the storage 8, and controls their operations. The control unit 6 controls radiation of the laser light by controlling the laser oscillator 2. The control unit 6 controls power, frequency, duty ratio, energy density, and the like of the laser light produced by the laser oscillator 2.

Also, the control unit 6 controls movement of the laser head 4 and the processing table 5 by controlling the drive unit 7. In other words, by controlling the drive unit 7, the control unit 6 can control the relative movement of the laser head 4 and the workpiece 10 placed on the processing table 5. By controlling the horizontal movement of the laser head 4 via the drive unit 7, the control unit 6 can control the movement direction, the amount of movement, the processing speed, and the like. Also, by controlling the vertical movement of the laser head 4, the control unit 6 can adjust the focal position of the laser light. Note that the control unit 6 may control the vertical movement of the processing table 5.

The storage 8 is a storage device such as a hard disk and provided in the computer device. The storage 8 stores processing programs used by the laser processing apparatus 1 and various data such as set values for processing performed by the laser processing apparatus 1. Note that the storage 8 may be included in the control unit 6.

The workpiece 10 with a protective sheet 11 attached on its top surface is the object to be processed. The workpiece 10 is placed on the processing table 5 and processed by the laser light radiated from the laser head 4. The protective sheet 11 protects the top surface of the workpiece 10. This protects the workpiece 10 from being damaged by external impacts.

Also, the protective sheet 11 is made of a material suitable for the wavelength of the laser light used by the laser processing apparatus 1 so that the laser light can perform marking processing. The protective sheet 11 is attached on the top surface of the workpiece 10 by adhesive and can be peeled off if necessary. The laser processing apparatus 1 can perform laser processing on the workpiece 10, with the protective sheet 11 attached to the workpiece 10.

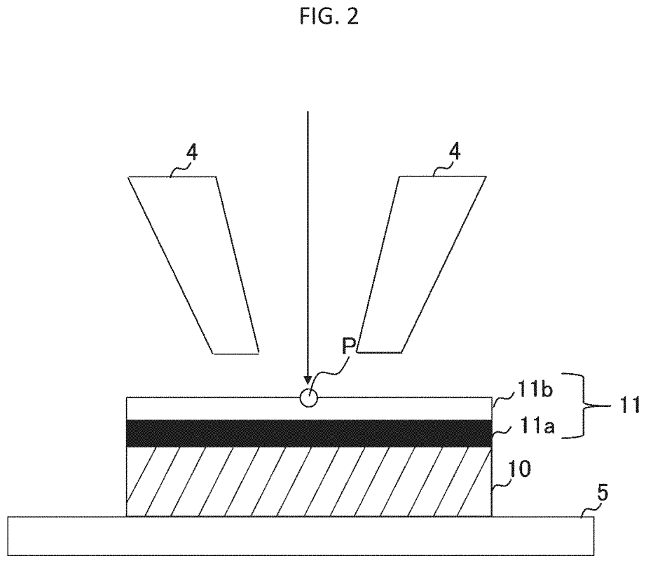

Next, laser processing will be described with reference to FIG. 2. FIG. 2 shows an enlarged view near a processing point of the workpiece 10 in FIG. 1. The processing point is a part where processing is being performed by the laser light radiated by the laser processing apparatus 1. In FIG. 2, only the tip of the laser head 4, which is close to the processing point, is shown for explanatory convenience. The direction of the arrow indicates the direction in which the laser light is radiated. The circled spot at the tip of the arrow indicates a processing point P. In this figure, it is shown that the laser processing apparatus 1 radiates the laser light toward the processing point P, where the processing takes place.

As shown in FIG. 2, the protective sheet 11 having a two-layered structure is attached to the workpiece 10. This protective sheet 11 includes a laser light absorbing layer 11a with high absorbency of the laser light and a laser light transmission layer 11b with low absorbency of the laser light. The protective sheet 11 has the laser light absorbing layer 11a on the side facing the top surface of the workpiece 10 and the laser light transmission layer 11b on the side of the laser head 4. That is, the protective sheet 11 has a structure where the laser light transmission layer 11b is stacked on top of the laser light absorbing layer 11a. Note that the protective sheet 11 does not necessarily have to include the laser light transmission layer 11b. Alternatively, there may be another layer between the laser light transmission layer 11b and the laser light absorbing layer 11a, and there may be another layer between the workpiece 10 and the laser light absorbing layer 11a.

The layers of the protective sheet 11 will be described. The laser light absorbing layer 11a, which is high in absorption of the laser light, is made of a natural rubber or a thermoplastic resin, colored in black or gray. For the natural rubber and the thermoplastic resin colored in black, those containing, as black pigment, a powder of carbon black or carbonized graphite, which are generally high in absorption of the laser light, can be used. The laser light absorbing layer 11a contains a material that develops adhesiveness to be attached to the workpiece 10. The black pigment is not limited to those mentioned above as long as the absorption rate of laser light is high. The laser light absorbing layer 11a achieves its high absorption rate of the laser light by containing a black pigment with a high absorption rate of the laser light. Here, when the absorption rate of the laser light is high, it means that, for example, the absorption rate of the laser light exceeds 30%. A pigment with an absorption rate of the laser light exceeding 30% absorbs the laser light to readily promote transformation of the laser light absorbing layer.

The laser light transmission layer 11b, which is low in absorption of the laser light, is made of an uncolored thermoplastic resin or a white-colored thermoplastic resin. For the thermoplastic resin colored in white, for example, those containing zinc oxide or titanium oxide, which are a white pigment generally low in absorption of the laser light, can be used. The white pigment is not limited to those mentioned above as long as the absorption rate of laser light is low. The laser light transmission layer 11b achieves its low absorption rate of the laser light by containing a white pigment with a low absorption rate of the laser light. Here, when the absorption rate of the laser light is low, it means that, for example, the absorption rate of the laser light is 30% or lower.

Note that the absorption rate of the laser light is not determined solely by the color of the laser light absorbing layer 11a. As long as a protective sheet has an absorption rate suitable for the laser light used by the laser processing apparatus 1, the protective sheet can be used as the protective sheet 11.

Regarding materials constituting each layer, the layer contains natural rubber. polyethylene, or the like as its main component. If the main component of the layer accounts for 50% or more by weight, another resin component or the like may be mixed.

For example, FIBERGUARD (registered trademark) SPV-310GH series, manufactured by Nitto Denko Corporation, can be used for the protective sheet 11. Note that the thickness of the protective sheet 11 is not particularly limited, but the protective sheet 11 having a thickness of 0.050 mm to 0.200 mm is preferable because it has good workability when attaching it on the workpiece 10. The numerical range given above includes both of the upper and lower limits that define the numerical range. This is also the case in the following description unless otherwise noted.

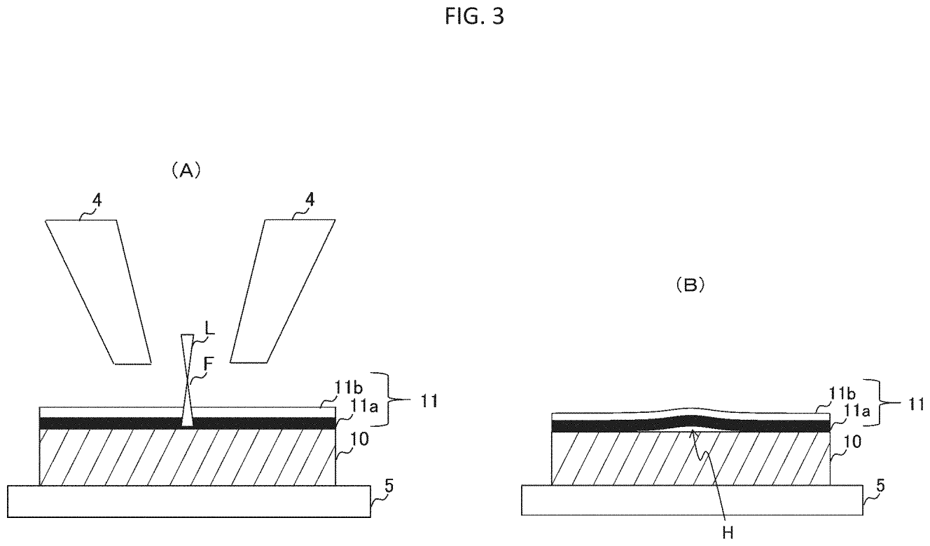

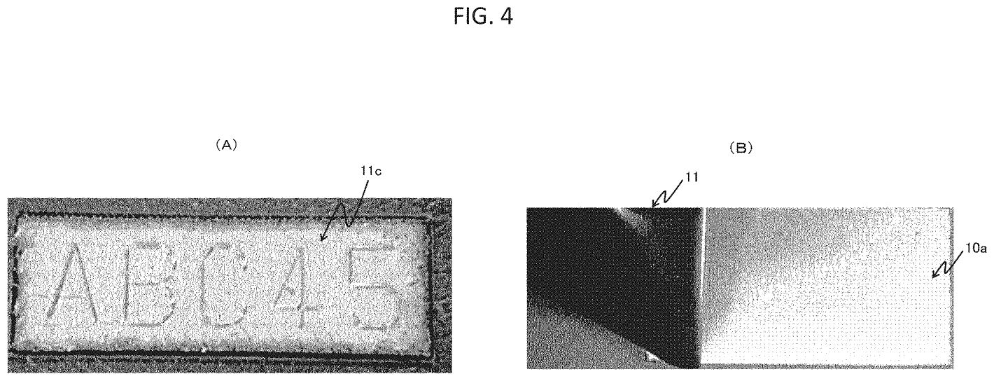

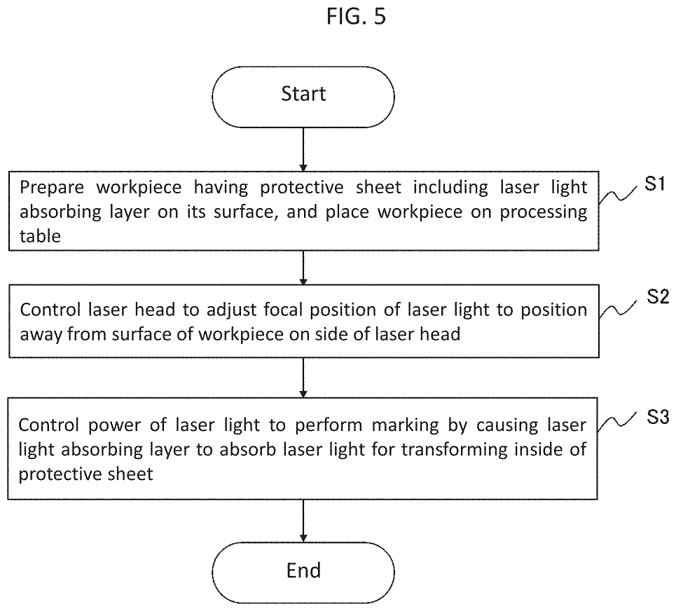

Next, the operation of the laser processing apparatus 1 will be described using FIG. 3 to FIG. 5. FIG. 3A shows a schematic layout during laser processing by the laser processing apparatus 1, and FIG. 3B shows a schematic diagram of a workpiece after laser processing by the laser processing apparatus 1. FIG. 4A is an image showing an example of the protective sheet 11 after laser processing by the laser processing apparatus 1, and FIG. 4B is an image showing an example of the workpiece 10 after laser processing by the laser processing apparatus 1. FIG. 4B shows an image in which a part of the protective sheet 11 is peeled off from the workpiece 10 shown in FIG. 4A. FIG. 5 shows a flowchart showing the flow of laser processing by the laser processing apparatus 1.

FIG. 3A schematically shows how laser light L is radiated to the laser light absorbing layer 11a of the protective sheet 11. The focal position F of the laser light L is adjusted to a position away from the top surface of the workpiece 10 on the side of the laser head 4. In practice, the focal position F of the laser light L is adjusted to a position away from the surface of the protective sheet 11 on the side of the laser head 4. The focal position F is adjusted to a state where the processing point is at a so-called defocused position. The energy density of the laser light L is highest at the focal position where the laser light is concentrated. In view of this, in the present embodiment, the focal position F is adjusted to a position defocusing the processing point in such a way that the energy density of the laser light L irradiating the workpiece 10 is lower than the energy density of the laser light L at the focal position. This also applies to the other embodiments.

By adjusting the focal position F to the position defocusing the processing point as described above, the laser light of the energy density lower than the energy density at the focal position F can irradiate the inside of the protective sheet 11. In other words, by adjusting to the defocused position, it is possible to avoid irradiating the laser light absorbing layer 11a locally with the laser light having a high energy density. Therefore, it is possible to prevent the laser light from cutting off the protective sheet 11 and damaging the workpiece 10.

With the top surface of the workpiece 10 set as the reference level, the position defocusing the processing point can be represented by the distance from the reference level to the focal position F. The position of the top surface of the workpiece 10 is set to 0 as the reference level. Then, if the focal position F is located on the side of the laser head 4, the focal position is represented by a positive value (+) in unit of mm.

On the other hand, if the focal position F is located on the opposite side of the laser head 4, the focal position is represented by a negative value (−) in unit of mm. For example, if the focal position F is located 10 mm away from the top surface of the workpiece 10 on the side of the laser head 4, the focal position is +10 mm.

The position defocusing the processing point is set, for example, at a position 0.5 mm to 10 mm away from the top surface of the workpiece 10 on the side of the laser head 4, that is, a position within the range of +0.5 mm to +10 mm. Further, the position defocusing the processing point should preferably be within the range of +2 mm to +8 mm, and more preferably within the range of +4 mm to +6 mm in view of the energy density of the laser light irradiating the protective sheet 11. With the position defocusing the processing point set at a distance from the protective sheet 11, the processing is affected neither by the vibration coming from the installation environment of the apparatus during the processing nor by the roughness of the surface of the protective sheet or the workpiece itself, and thus the protective sheet 11 is not cut off by the laser light of high energy density at the focal position. In this way, setting to the defocused position has a beneficial effect on ensuring stable quality of the marking processing to the protective sheet.

Next, FIG. 3B will be described. FIG. 3B shows the state after irradiating the protective sheet 11, attached to the workpiece 10, with the laser light. As shown in FIG. 3B, the laser light absorbing layer 11a irradiated with the laser light and the top surface of the workpiece 10 are separated from each other to form a space H. That is, the protective sheet 11 is internally transformed. This indicates that the laser light has transformed the protective sheet 11 by transforming the laser light absorbing layer 11a without damaging the workpiece 10 or breaking the protective sheet 11.

Thus, when observed from the side of the top surface of the workpiece 10 on which the protective sheet 11 is attached, the transformed portion on the protective sheet 11 can be visually recognized. This transformation of the protective sheet 11 can be recognized as marking. Besides the transformation of the protective sheet 11 as shown in FIG. 3B, the transformation occurring inside the protective sheet 11 also includes the transformation producing a cavity inside the protective sheet 11 itself, causing a change in relief on the surface of the protective sheet 11.

In the laser processing apparatus 1, the power of the laser light is controlled to perform the marking by causing the laser light absorbing layer 11a to absorb the laser light and transforming the inside of the protective sheet 11. The power of this laser light is changed appropriately in accordance with the focal position defocusing the processing point. The power of the laser light is controlled, for example, from 50 to 100 W to transform the inside of the protective sheet 11. The power of the laser light is preferably set to 70 to 90 W to reliably transform the inside of the protective sheet 11. Note that, when cutting sheet metal using a fiber laser, the power of the laser light is usually set to, for example, 1 kW or higher. Therefore, in other words, one of the features of the laser processing apparatus of the present embodiment is that the power of the laser light used when performing the marking is set considerably lower than the power of the laser light used in normal laser processing.

As described above, the power of the laser light is controlled so as to transform the inside of the protective sheet 11 by adjusting the focal position to the position defocusing the processing point and by causing the laser light absorbing layer 11a to absorb the laser light. As a result, the marking is provided on the protective sheet 11. Also, since the focal position is brought to the position defocusing the processing point, the marking is performed by the laser light lower in energy density. This makes the control of the laser light easier compared to the control performed in the conventional technique, which strictly controls the radiation of the laser light with respect to the surface of the protective sheet.

The laser light absorbing layer 11a absorbs the laser light and is heated by the thermal energy, thereby being transformed. Due to the transformation of the laser light absorbing layer 11a, the laser light transmission layer 11b is also transformed. Due to the transformation of these two layers, the protective sheet 11 is transformed. The term “marking” used in the description of the present embodiment shall not include the marking caused by the destruction of the surface of the protective sheet 11, such as grooving, cutting, and the like given by the laser light. This also applies to the other embodiments.

If the laser light is applied, with the laser head 4 being moved along a predetermined trajectory, on the protective sheet 11 in accordance with the conditions for providing the marking thereon, the predetermined trajectory is marked on the sheet. By performing the laser processing in this way, the marking of a desired shape can be provided on the protective sheet 11 without destroying the sheet.

Since the marking is provided by transforming the inside of the protective sheet 11, the laser light does not damage the workpiece 10. Since the protective sheet 11 is not cut off, no foreign matter is generated from the protective sheet 11. Since a layer colored in black, having a high absorption rate for the laser light, is used as the laser light absorbing layer 11a, the transformation of the laser light absorbing layer 11a by the energy of the laser light is promoted, which reliably prevents the processing from reaching the top surface of the workpiece 10. Since a layer colored in white, having a low absorption rate for the laser light, is used as the laser light transmission layer 11b, the visibility of the marking can be improved.

Next, the workpiece, on which the laser processing was actually performed, will be described with reference to FIG. 4. FIG. 4A is a picture image of the surface of the protective sheet 11 of the workpiece 10, on which the laser processing was actually performed. FIG. 4B is a picture image of a state in which a part of the protective sheet 11 is peeled off from the workpiece 10 shown in FIG. 4A to expose the top surface of the workpiece 10.

As shown in FIG. 4A, it is recognized that the surface 11c of the protective sheet has a marking in which letters and numbers are lined up as “ABC45”. This indicates that as a result of the irradiation of the protective sheet 11 with the laser light, transformation occurred inside the protective sheet 11, thereby providing the marking. In the marking portion, the top surface of the workpiece 10 is not exposed. Also, although not shown, when a cross-sectional image of the workpiece 10 and the protective sheet 11 after the laser processing is examined, it is confirmed that spaces are formed between the top surface 10a of the workpiece 10 and the protective sheet 11.

Also, from FIG. 4B, it can be seen that the top surface 10a of the workpiece 10 is not damaged in any way. That is, the laser processing by the laser processing apparatus 1 is performed only for the protective sheet 11 and not for the workpiece 10. Thus, the laser processing apparatus 1 can provide the marking on the protective sheet 11 without damaging the workpiece 10.

Returning to FIG. 3, the mechanism enabling the laser processing apparatus 1 to perform the marking will be described. When the laser light is radiated with the focal position F adjusted to the position defocusing the processing point on the side of the laser head 4 as shown in FIG. 3A, the laser light penetrates the laser light transmission layer 11b and is absorbed by the laser light absorbing layer 11a. When the laser light is absorbed by the laser light absorbing layer 11a, the material, such as a rubber, a resin, or the like constituting the laser light absorbing layer 11a, generates heat and then melts.

Even after the material constituting the laser light absorbing layer 11a melts, the absorption of the laser light continues, and the energy is stored. This evaporates the melted material. The gas generated by the evaporation of the material forms a space between the protective sheet 11 and the workpiece 10. As the gas increases due to the evaporation of the material, the protective sheet 11 is transformed in a way that it is pushed up from the inside. As a result, the laser light absorbing layer 11a is separated from the workpiece 10 and the space H is formed. The state in FIG. 3B is reached through these processes.

Note that, in the present embodiment, the power of the laser light is controlled, with the focal position brought to the position defocusing the processing point, in order to provide the marking by transforming the inside of the protective sheet 11 without destroying it. Therefore, it is important to control the energy of the laser light to be given to the laser light absorbing layer. The control of the laser light to be performed by the control unit 6, however, is not limited to the control of the position defocusing the processing point and the power of the laser light, but further includes the control of other various conditions involving the laser light. This also applies to the other embodiments.

The setting of the other various conditions of the laser light in performing the marking includes, for example, setting the frequency of the laser light to 50 to 100 Hz, the duty ratio thereof to 5 to 10%, and the processing speed to 500 to 1000 mm/min. The frequency of the laser light may be set to 70 to 90 Hz. The conditions for the frequency and the duty ratio of the laser light and the processing speed are not limited to the above, but can be changed as needed depending on the materials used for the protective sheet 11 and the thickness of the sheet.

Next, a laser processing method used by the laser processing apparatus 1 will be described with reference to the flowchart shown in FIG. 5.

Before starting the laser processing by the laser processing apparatus 1, the workpiece 10 having the protective sheet 11 attached thereon, the protective sheet 11 including the laser light absorbing layer 11a, is prepared and placed on the processing table 5 of the laser processing apparatus 1 (S1).

Next, the control unit 6 of the laser processing apparatus 1 controls the laser head 4 to adjust the focal position of the laser light to a position away from the surface of the protective sheet 11 on the side of the laser head 4, that is, the position defocusing the processing point (S2: the focal position adjustment step). While doing this, the control unit 6 also controls the drive unit 7 to move the laser head 4 to a position corresponding to the processing point of the workpiece 10.

Next, the control unit 6 of the laser processing apparatus 1 controls the power of the laser light to perform processing in a way that the marking is provided by causing the laser light absorbing layer 11a to absorb the laser light and thus transforming the inside of the protective sheet 11 (S3: the laser light power control step). Note that the control unit 6 controls the other various conditions and parameters of the laser light in controlling the power of the laser light to perform the processing. The various conditions and parameters may be set in advance.

By performing the laser processing by the laser processing apparatus 1, following the steps described above, the marking is provided on the protective sheet 11 without damaging the workpiece 10. Regarding the order of the above steps, if the position of the surface of the protective sheet 11 is known from the information on the thickness of the workpiece 10 before performing the laser processing, S2 and S1 in the above steps may be swapped.

### Embodiment 2

A laser processing apparatus 1 according to Embodiment 2 will be described below.

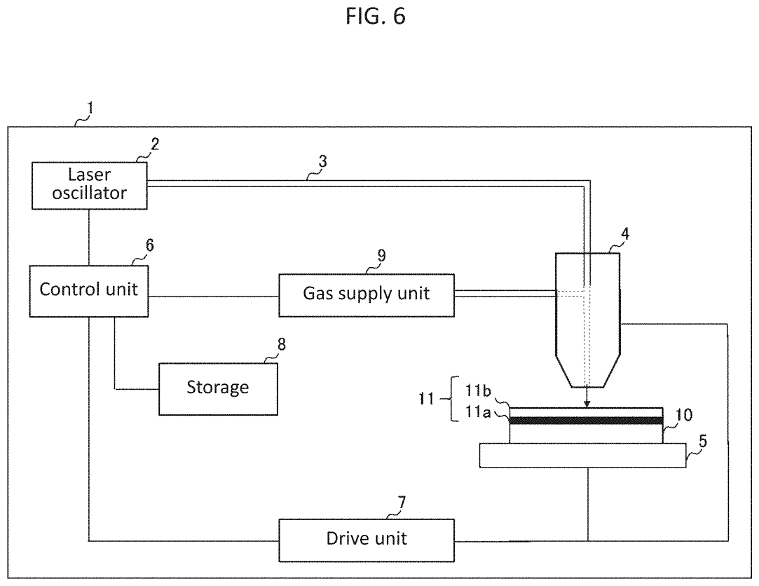

The laser processing apparatus 1 according to Embodiment 2 will be described using FIG. 6 to FIG. 9. FIG. 6 shows a configuration diagram of the laser processing apparatus 1 according to Embodiment 2. As shown in FIG. 6, the laser processing apparatus 1 includes a gas supply unit 9 in addition to the configuration of the laser processing apparatus 1 according to Embodiment 1. In the following description, the configuration different from that in Embodiment 1 will be mainly described.

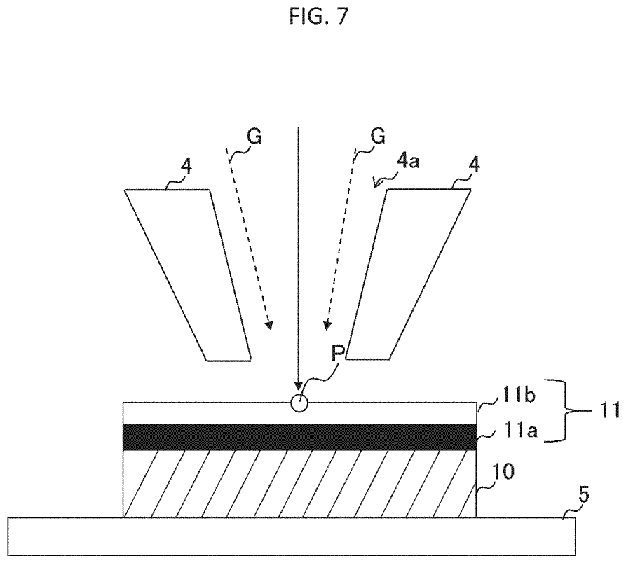

The gas supply unit 9, which is connected to the control unit 6, supplies and stops an assist gas by being controlled by the control unit 6. The gas supply unit 9 supplies the assist gas to the laser head 4 through a gas supply pipe provided for delivering the assist gas. FIG. 7 shows an enlarged view near the processing point of the workpiece shown in FIG. 6. FIG. 7 is an example of the laser processing apparatus 1 using the assist gas. As shown in FIG. 7, the assist gas supplied to the laser head 4 flows through a distribution unit, which is a delivery hole 4a provided in the center of the laser head 4, and is discharged from the tip of the laser head 4. With this configuration, the laser head 4 can radiate the laser light while jetting the assist gas.

In laser processing, melt is produced from the workpiece 10. In general laser processing, the laser head 4 radiates the laser light while jetting the assist gas during processing of the workpiece 10, so that the assist gas blows off the melt produced from the workpiece 10. Nitrogen gas or oxygen gas is used for the assist gas.

The control unit 6 can adjust the pressure and flow rate of the assist gas by controlling the gas supply unit 9. The control unit 6 can change the type of the assist gas by switching a gas supply valve of the gas supply unit 9. The pressure of the assist gas supplied from the gas supply unit 8 is set, for example, to 0.1 MPa to 0.5 MPa.

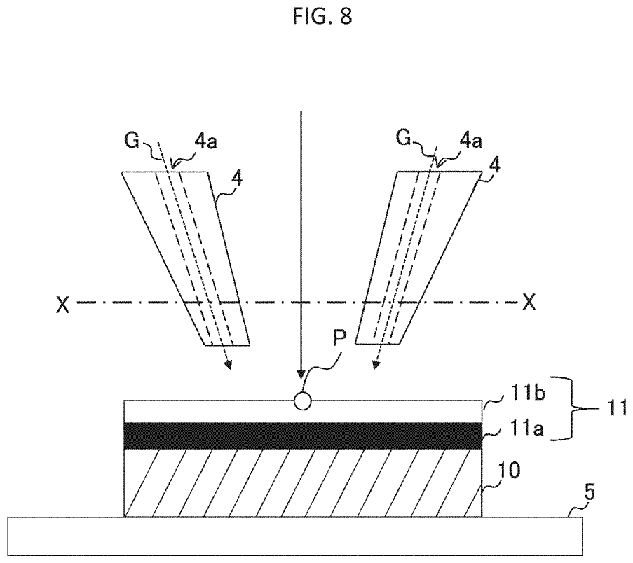

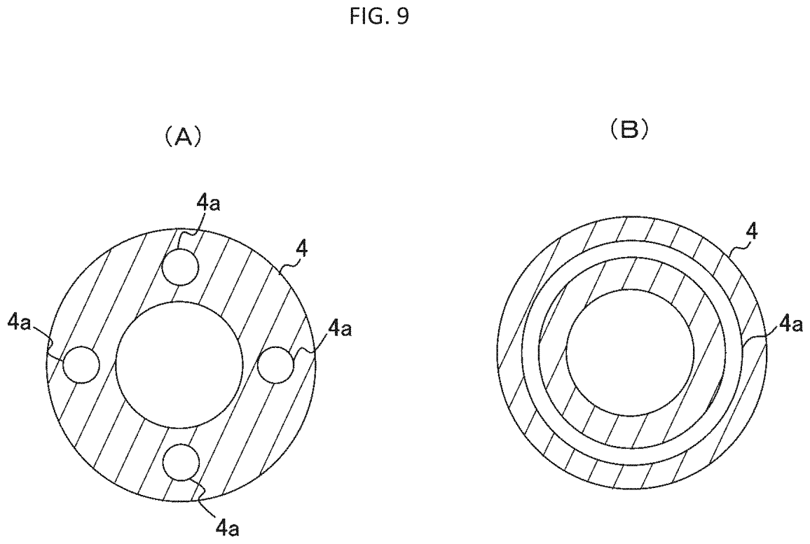

FIG. 8 is a diagram showing the vicinity of the tip of the laser head 4 of the laser processing apparatus 1 according to Embodiment 2. As shown in FIG. 8, the laser head 4 includes delivery holes 4a as the distribution unit inside its main body and is configured such that the assist gas flows through the inside of the main body of the laser head 4. FIG. 9 shows a cross section taken along the line X-X in FIG. 8. As shown in FIG. 9A, the laser head 4 has a circular cross section. The laser head 4 has four assist gas delivery holes 4a inside its main body. The four delivery holes 4a are evenly spaced from each other and along the circumferences of the laser head 4.

The control unit 6 controls the gas supply unit 9 to supply the assist gas via the distribution unit. The control unit 6 can control the gas supply unit 9 so as to select at least one of the four delivery holes 4a for supplying the assist gas. With this configuration, the laser processing apparatus 1 can jet the assist gas to a predetermined position about the processing point P during the laser processing.

The laser processing apparatus 1 supplies the assist gas by controlling the gas supply unit 9 using the control unit 6 in performing the marking described in Embodiment 1. The control unit 6 can supply the assist gas from the gas supply unit 9 in a way suitable for performing the marking. With this configuration, in performing the marking, the laser processing apparatus 1 can cool the marking portion, which is heated by the laser light, by jetting the assist gas therearound. By cooling the marking portion, further transformation due to the heat remaining in the protective sheet 11 can be suppressed, and thus the peeling off of the protective sheet 11 can be prevented.

Further, the control unit 6 can select the delivery holes 4a to supply the assist gas by controlling the gas supply unit 9. Therefore, the assist gas can be jetted in accordance with the shape of the marking. This configuration prevents excessive cooling, caused by the assist gas, from making the marking unclear.

Notwithstanding the above example, the number of the delivery holes 4a to be arranged along the circumferences may be five or more, or three or less. The cross-sectional shape of the delivery holes 4a is not limited to a circular shape, but may be a triangular, a quadrangular, or a polygonal shape. Alternatively as shown as a variation in FIG. 9B, a delivery hole 4a having a ring-shaped cross section may be provided along the circumferences.

Further, as a variation of Embodiment 2, the assist gas can be supplied in accordance with the direction of marking processing. To give specific description on the direction of marking processing, when marking processing is in progress by controlling the movement of the laser head 4 along the shape of the marking, the direction in which the laser head 4 is moving is the direction of marking processing. For example, the distribution unit may be provided in such a way that the assist gas can be jetted from behind the marking being performed by the laser processing apparatus 1.

The control unit 6 controls the gas supply unit 9 to jet the assist gas as the marking progresses. In this configuration, the assist gas is jetted only from behind the marking in progress. Therefore, only the portion where the marking is completed is cooled, and the portion where the marking is not completed is not cooled. As a result, the marking becomes clearer.

As another variation, the assist gas can be supplied in accordance with the shape of the marking. The term “shape of the marking” here refers to a shape, such as line, that is being drawn during a given processing time in the marking processing. For example, when the laser processing apparatus 1 is drawing a straight line in the marking processing, the assist gas can be jetted through the distribution unit, by controlling the gas supply unit 9, in a way that the straight line having been drawn is sandwiched by blows of the assist gas.

With this configuration, the laser processing apparatus 1 can reliably prevent the peeling off of the protective sheet 11 that might be caused by the marking, because the assist gas jetted to surround the shape of the marking compacts the protective sheet 11 along the shape of the marking.

### Embodiment 3

A laser processing apparatus 1 according to Embodiment 3 will be described below.

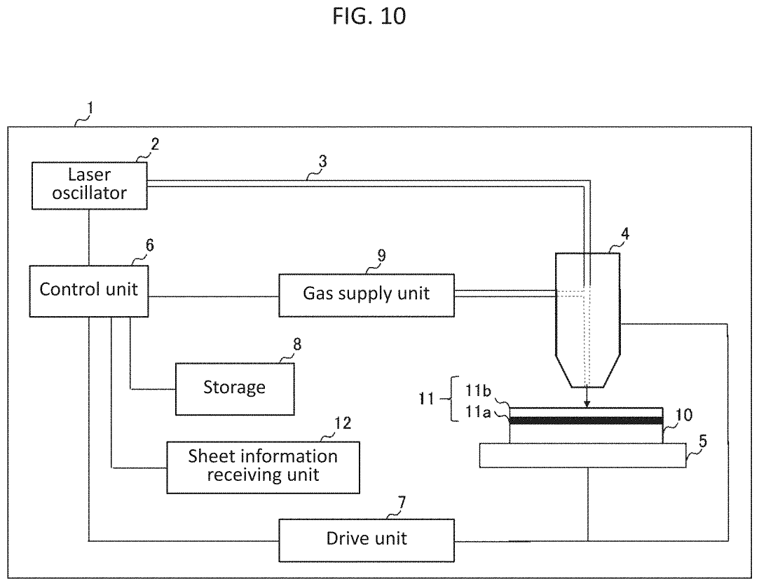

The laser processing apparatus 1 according to Embodiment 3 will be described with reference to FIG. 10. FIG. 10 shows a configuration diagram of the laser processing apparatus 1 according to Embodiment 3. As shown in FIG. 10, the laser processing apparatus 1 includes a sheet information receiving unit 12 in addition to the configuration of the laser processing apparatus 1 of Embodiment 2. In the following description, a configuration different from that in Embodiments 1 and 2 will be mainly described.

The sheet information receiving unit 12, which is connected to the control unit 6, sends information about the protective sheet 11 to the control unit 6. Note that the sheet information receiving unit 12 may be included in the control unit 6.

The sheet information receiving unit 12 receives sheet information about the protective sheet, the sheet information being externally inputted to the laser processing apparatus 1. For example, it receives the sheet information inputted by an operator through an input interface or the like. Note that the sheet information may be read from a barcode or two-dimensional bar code representing information associated with the sheet information using a reader connected to the laser processing apparatus 1. The reader connected to the laser processing apparatus 1 may automatically read the sheet information from the workpiece 10 placed on the processing table 5.

Here, the term “sheet information” means information about the protective sheet 11 attached on the workpiece 10 that is the target of laser processing. The sheet information includes, for example, information on material, layer composition, thickness, product number, and absorption rate of laser light, of the protective sheet 11.

The sheet information receiving unit 12 transmits the received sheet information to the control unit 6. The control unit 6 reads, out of the storage 8, the marking conditions corresponding to the sheet information received from the sheet information receiving unit.

Here, the marking conditions include, for example, the position of the laser head 4 corresponding to the position defocusing the processing point and the power conditions of the laser light, the position and the conditions having been specified for each sheet as the sheet information. The marking conditions may further include conditions on laser light such as frequency and duty ratio, processing speed, type of assist gas, assist gas pressure, assist gas flow rate, and the like. Note that it is assumed here that the marking conditions corresponding to the sheet information are stored in the storage 8 before the marking is performed.

The control unit 6 reads the marking conditions corresponding to the sheet information from the storage 8, and then, sets the position of the laser head 4 and the power of the laser light based on the marking conditions. If the marking conditions include other various conditions, the control unit 6 makes a setting for the other various conditions. The control unit 6 performs the marking processing based on the set conditions. As described above, the laser processing apparatus 1 can set the marking conditions based on the inputted sheet information, so that the marking can be performed efficiently with easy operation.

Further, in a variation of the Embodiment 3, test processing can be performed according to the marking conditions corresponding to the sheet information set by the laser processing apparatus 1. The test processing is processing to check whether the marking can be performed correctly on the workpiece 10 according to the set marking conditions, before actually performing the marking.

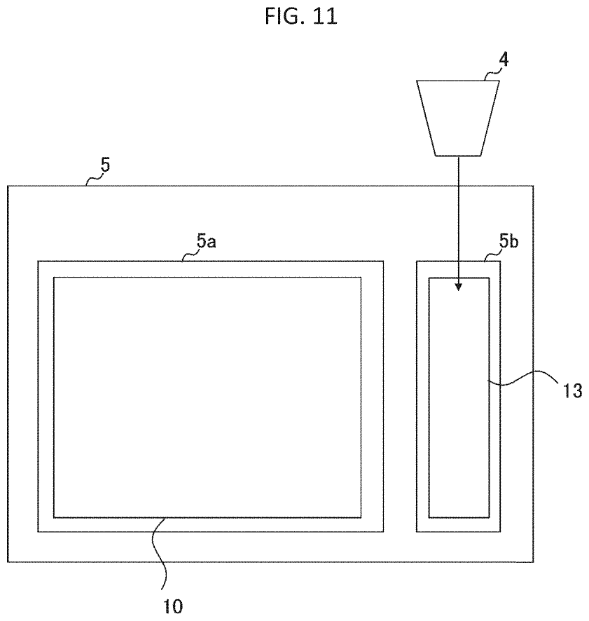

The variation will be described with reference to FIG. 11. FIG. 11 is a plan view showing a state in which the workpiece 10 is placed on the processing table 5. The processing table 5 includes a workpiece processing area 5a for performing the processing of the workpiece 10 and a test processing area 5b, which is arranged outside the workpiece processing area, for performing the test processing of the test workpiece 13. The workpiece processing area 5a has the workpiece 10 placed thereon, and the test processing area 5b has the test workpiece 13 placed thereon. This figure schematically shows how the laser light, indicated by an arrow, is radiated to the test workpiece 13 from the laser head 4. Note that the sizes of the workpiece processing area 5a and the test processing area 5b are not limited to those.

The laser processing apparatus 1 sets the position of the laser head 4 and the power of the laser light according to the marking conditions corresponding to the sheet information. The laser processing apparatus 1 performs, according to the set conditions, the marking processing on the test workpiece 13 placed on the test processing area. This configuration allows checking whether the marking will be provided correctly on the workpiece 10 before actually performing the marking processing, so that the laser processing apparatus 1 makes it possible to prevent marking error from occurring on the workpiece 10.

For the test workpiece 13, it is preferable in terms of workability to use a workpiece which is of the same configuration as, but smaller in size than, the workpiece 10 to which the marking is actually provided. Further, when the marking as test processing is performed, a test workpiece 13 may be placed on the test processing area 5b, or an appropriate test workpiece 13 may be selected based on the received sheet information and automatically placed on the test processing area 5b.

The above is description of the embodiments of this disclosure. However, the laser processing apparatus and the laser processing method of the present invention are not limited to the forms described in Embodiments 1 to 3 and their variations, which all only indicate a part of the present invention. The laser processing apparatus and the laser processing method of this disclosure may be combined with other known techniques. Further, it is possible to combine, omit and change in part the configurations as appropriate without departing from the gist of the disclosure.

### DESCRIPTION OF THE SYMBOLS

1 laser processing apparatus
2 laser oscillator
3 transmission unit
4 laser head
4a delivery hole
5 processing table
5a workpiece processing area
5b test processing area
6 control unit
7 drive unit
8 storage
9 gas supply unit
10 workpiece
10a surface of workpiece
11 protective sheet
11a laser light absorbing layer
11b laser light transmission layer
11c surface of protective sheet
12 sheet information receiving unit
13 test workpiece

1.-7. (canceled)

8. A laser processing apparatus comprising:
a laser oscillator to generate laser light;
a processing table to place a workpiece thereon, the workpiece having a protective sheet on a surface thereof, the protective sheet including a laser light absorbing layer;
a laser head to process the workpiece with the laser light; and
controlling circuitry to adjust a position of the laser head so that a focal position of the laser light is brought to a position away from the surface of the workpiece toward the laser head, and to control power of the laser light so that marking is provided by causing the laser light absorbing layer to absorb the laser light and thus transforming the inside of the protective sheet.

9. The laser processing apparatus according to claim 8, wherein
the protective sheet further includes a laser light transmitting layer stacked on the laser light absorbing layer, and
the controlling circuitry transforms the laser light absorbing layer by causing the laser light absorbing layer to absorb the laser light and transforms the laser light transmitting layer in accordance with the transformation of the laser light absorbing layer.

10. The laser processing apparatus according to claim 9, wherein the laser light absorbing layer of the protective sheet is a layer colored with a black pigment that absorbs the laser light and the laser light transmitting layer of the protective sheet is a layer colored with a white pigment that transmits the laser light.

11. The laser processing apparatus according to claim 8, further comprising:
a gas supply unit controlled by the controlling circuitry to supply the laser head with an assist gas to be jetted to the workpiece; and
a distribution unit provided in the laser head to deliver the assist gas supplied from the gas supply unit, wherein
the controlling circuitry controls the supply of the assist gas in accordance with processing of the marking.

12. The laser processing apparatus according to claim 9, further comprising:
a gas supply unit controlled by the controlling circuitry to supply the laser head with an assist gas to be jetted to the workpiece; and
a distribution unit provided in the laser head to deliver the assist gas supplied from the gas supply unit, wherein
the controlling circuitry controls the supply of the assist gas in accordance with processing of the marking.

13. The laser processing apparatus according to claim 10, further comprising:
a gas supply unit controlled by the controlling circuitry to supply the laser head with an assist gas to be jetted to the workpiece; and
a distribution unit provided in the laser head to deliver the assist gas supplied from the gas supply unit, wherein
the controlling circuitry controls the supply of the assist gas in accordance with processing of the marking.

14. The laser processing apparatus according to claim 8, further comprising:
a sheet information receiving circuitry to receive sheet information about the protective sheet, the sheet information being inputted externally; and
a storage to store marking conditions based on the sheet information, wherein
the sheet information receiving unit transmits the received sheet information to the controlling circuitry, and
the controlling circuitry reads the marking conditions corresponding to the sheet information out of the storage based on the sheet information received from the sheet information receiving unit and sets the position of the laser head and the power of the laser light based on the marking conditions.

15. The laser processing apparatus according to claim 9, further comprising:
a sheet information receiving unit to receive sheet information about the protective sheet, the sheet information being inputted externally; and
a storage to store marking conditions based on the sheet information, wherein
the sheet information receiving unit transmits the received sheet information to the controlling circuitry, and
the controlling circuitry reads the marking conditions corresponding to the sheet information out of the storage based on the sheet information received from the sheet information receiving unit and sets the position of the laser head and the power of the laser light based on the marking conditions.

16. The laser processing apparatus according to claim 10, further comprising:
a sheet information receiving unit to receive sheet information about the protective sheet, the sheet information being inputted externally; and
a storage to store marking conditions based on the sheet information, wherein
the sheet information receiving unit transmits the received sheet information to the controlling circuitry, and
the controlling circuitry reads the marking conditions corresponding to the sheet information out of the storage based on the sheet information received from the sheet information receiving unit and sets the position of the laser head and the power of the laser light based on the marking conditions.

17. The laser processing apparatus according to claim 11, further comprising:
a sheet information receiving unit to receive sheet information about the protective sheet, the sheet information being inputted externally; and
a storage to store marking conditions based on the sheet information, wherein
the sheet information receiving unit transmits the received sheet information to the controlling circuitry, and
the controlling circuitry reads the marking conditions corresponding to the sheet information out of the storage based on the sheet information received from the sheet information receiving unit and sets the position of the laser head and the power of the laser light based on the marking conditions.

18. The laser processing apparatus according to claim 12, further comprising:
a sheet information receiving unit to receive sheet information about the protective sheet, the sheet information being inputted externally; and
a storage to store marking conditions based on the sheet information, wherein
the sheet information receiving unit transmits the received sheet information to the controlling circuitry, and
the controlling circuitry reads the marking conditions corresponding to the sheet information out of the storage based on the sheet information received from the sheet information receiving unit and sets the position of the laser head and the power of the laser light based on the marking conditions.

19. The laser processing apparatus according to claim 8, wherein
the processing table includes a workpiece processing area where the workpiece is processed and a test processing area outside the workpiece processing area, and
the controlling circuitry makes settings for the position of the laser head and the power of the laser light and performs test processing in the test processing area according to the settings.

20. The laser processing apparatus according to claim 9, wherein
the processing table includes a workpiece processing area where the workpiece is processed and a test processing area outside the workpiece processing area, and
the controlling circuitry makes settings for the position of the laser head and the power of the laser light and performs test processing in the test processing area according to the settings.

21. The laser processing apparatus according to claim 10, wherein
the processing table includes a workpiece processing area where the workpiece is processed and a test processing area outside the workpiece processing area, and
the controlling circuitry makes settings for the position of the laser head and the power of the laser light and performs test processing in the test processing area according to the settings.

22. The laser processing apparatus according to claim 11, wherein
the processing table includes a workpiece processing area where the workpiece is processed and a test processing area outside the workpiece processing area, and
the controlling circuitry makes settings for the position of the laser head and the power of the laser light and performs test processing in the test processing area according to the settings.

23. The laser processing apparatus according to claim 12, wherein
the processing table includes a workpiece processing area where the workpiece is processed and a test processing area outside the workpiece processing area, and
the controlling circuitry makes settings for the position of the laser head and the power of the laser light and performs test processing in the test processing area according to the settings.

24. The laser processing apparatus according to claim 14, wherein
the processing table includes a workpiece processing area where the workpiece is processed and a test processing area outside the workpiece processing area, and
the controlling circuitry makes settings for the position of the laser head and the power of the laser light and performs test processing in the test processing area according to the settings.

25. The laser processing apparatus according to claim 15, wherein
the processing table includes a workpiece processing area where the workpiece is processed and a test processing area outside the workpiece processing area, and
the controlling circuitry makes settings for the position of the laser head and the power of the laser light and performs test processing in the test processing area according to the settings.

26. The laser processing apparatus according to claim 17, wherein
the processing table includes a workpiece processing area where the workpiece is processed and a test processing area outside the workpiece processing area, and
the controlling circuitry makes settings for the position of the laser head and the power of the laser light and performs test processing in the test processing area according to the settings.

27. A laser processing method comprising:
adjusting a focal position of laser light to a position away from a surface of a workpiece toward a laser head by controlling the laser head for processing the workpiece with the laser light produced by a laser oscillator, the workpiece having a protective sheet on a surface thereof, the protective sheet including a laser light absorbing layer, and
controlling power of the laser light to provide marking by causing the laser light absorbing layer to absorb the laser light and thus transforming the inside of the protective sheet.
